(19) United States
(12) Patent Application Publication
(10) Pub. No.: US 2011/0315088 A1
(43) Pub. Date: Dec. 29, 2011

(54) Horse Bedding System

(75) Inventors: Ricky L. Yoder, Casco, WI (US); Paul A. Dongieux, JR., Oxford, MS (US)

(73) Assignee: KADANT GRANTEK INC., Green Bay, WI (US)

(21) Appl. No.: 13/165,489

(22) Filed: Jun. 21, 2011

Related U.S. Application Data
(60) Provisional application No. 61/357,837, filed on Jun. 23, 2010.

(51) Int. Cl. A01K 1/015; A01K 29/00

(52) U.S. Cl. 119/526; 119/171

(57) ABSTRACT

A large animal bedding system in which a large animal stall having a floor is provided with a bedding layer of cellulosic granules distributed across the floor of the stall. The system may include a shovel having a blade and a screen in the blade where the screen has a plurality of holes to assist in removing animal waste and agglomerated granules from the bedding layer.

### FIELD OF THE DISCLOSURE

This disclosure pertains to animal bedding and, more particularly, to a cellulosic granule-based large animal bedding system.

### BACKGROUND

Large animals confined in stalls or pens such as horses are provided with bedding materials to maintain a comfortable environment and to facilitate the collection and removal of the animals' waste products. Traditionally horses and other such large animals are bedded on straw. Straw, however, has significant disadvantages, including low moisture and odor absorbency. Also, straw is difficult to handle during removal. Nevertheless, horse and other large animal beddings may have to be completely stripped daily or at least weekly leading to significant expenditures for the cost of the straw (and other conventional large animal beddings) and for their handling.

The use of straw bedding also results in the formation of substantial discarded waste piles and the associated disposal problems. And, when there is a high percentage of straw present in the discarded waste it makes it extremely difficult to use the discarded material as a fertilizer. This means that burial in landfills is often required giving rise to yet further difficulties and expense. Finally, straw is palatable for herbivores and therefore horses and other large animals like cattle may consume contaminated straw bedding leading to indigestion and possibly to more serious medical issues.

Other types of beddings that have been used for large animals include pine or cedar wood shavings, chips and pellets. Unfortunately, these materials present airborne dust problems particularly as the shavings, chips and pellets are ground up under the animals' hooves. This dust may lead to respiratory problems for the animals and their handlers and attendants. Also, wood shavings, chips and pellets become muddy and sticky when wet with urine making it difficult to scoop out the spent bedding without replacing all of the bedding in the stall which is often undesirable because it gives rise to unnecessary expense and labor.

Finally, it is noted that products like scoopable cat litters are not used as bedding in large animal stalls and pens in part because scoopable cat litters are too expensive. More importantly however, scoopable cat litters would not work in large animal bedding applications because they become slippery when wet and therefore would make it difficult for both the large animals and the humans that attend to the animals to walk on. Finally, as in the case of the use of loose wood shavings, chips and pellets, there is the danger of inhalation of the scoopable litter particles, particularly as they become ground up under the weight of the animal's hooves.

### BRIEF DESCRIPTION OF THE DRAWINGS

Embodiments of the invention together with their objects and advantages, may be understood with reference to the following description, taken in conjunction with the following drawings, in which like reference numerals identify like elements in the figures, and in which:

FIG. 1 is a perspective view of a large animal stall with a bedding layer of cellulosic granules in accordance with a disclosed embodiment;

FIG. 1A is an enlarged partial view of cellulosic granules present the bedding layer in the stall of FIG. 1;

FIG. 2 is an perspective view of a shovel with a screen in its blade used for sifting soiled granular bedding in accordance with embodiments of the invention; and

FIG. 2A is an enlarged partial view of holes in the screen of the shovel of FIG. 2.

### SUMMARY OF THE INVENTION

There is therefore a need in the art for new improved large animal bedding systems that utilize bedding materials that are easy to handle, will not become slippery when wet, are readily composted, and will provide large animals with a comfortable cushioning surface on which to stand and rest. When we refer to “large animals” we intend to cover all livestock and other animals kept in stalls or on bedding but excluding Rodentia commonly kept as pets as well as rabbits and any other Lagomorpha kept as pets.

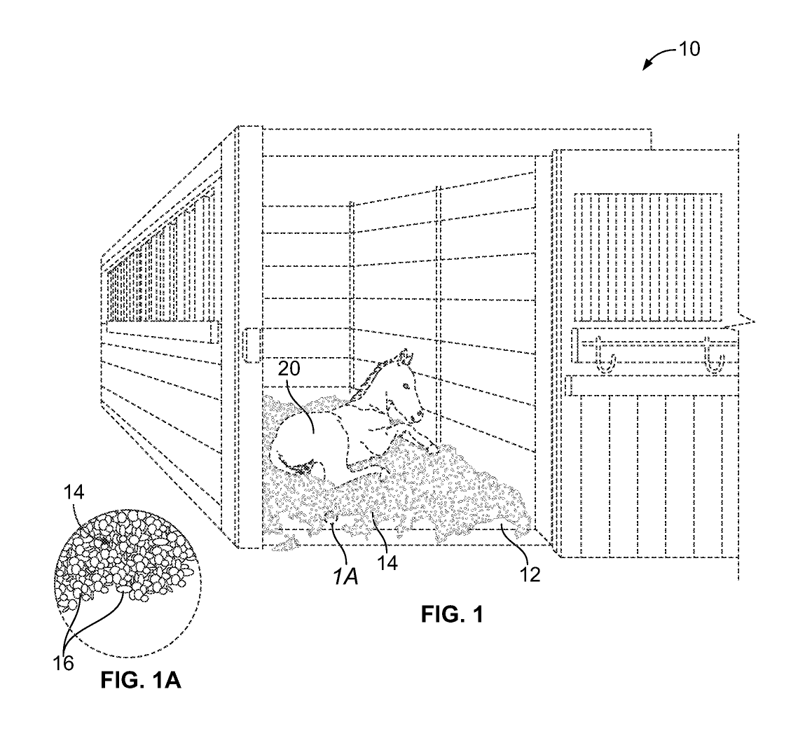

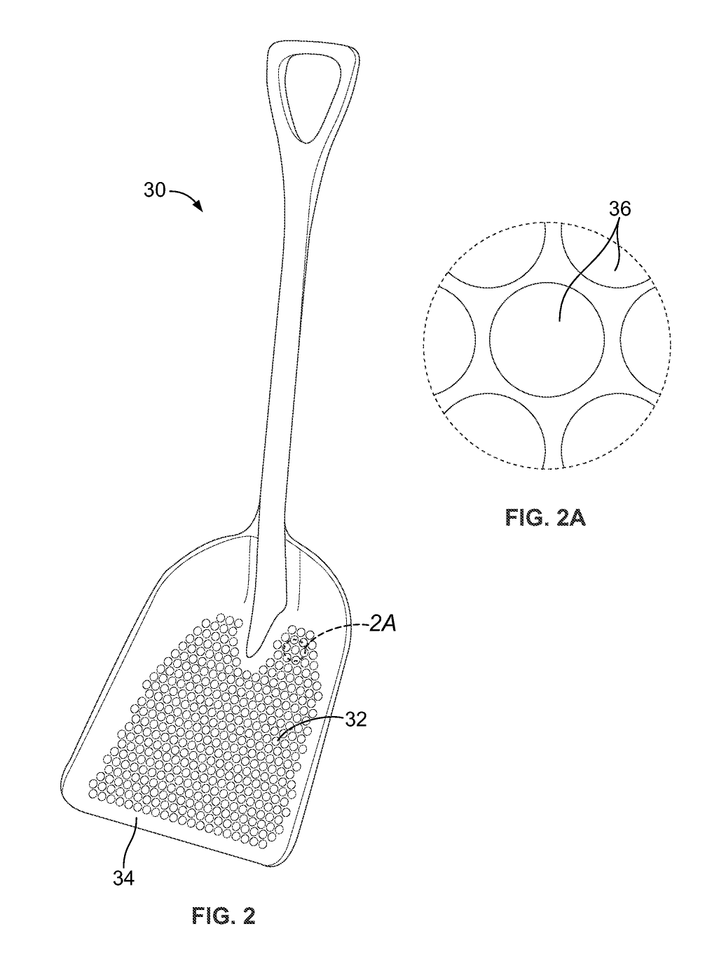

Embodiments of the invention are directed to such large animal bedding systems including a large animal stall 10 having a floor 12 and a bedding layer 14 of cellulosic granules 16 distributed across the floor 10 of the stall. The layer of cellulosic granules should be from about 0.5 to 6 inches in thickness and preferably will be from about 3 to 4 inches in thickness. As can be seen in FIG. 1, a large animal such as horse 20 may comfortably rest on bedding layer 14. Although it would have been expected that a layer of the cellulosic granules would stick to the animal's coat, in fact, the granules do not do so.

The cellulosic granules may be prepared, for example, in accordance with the teaching of U.S. Pat. No. 4,560,527, 4,619,862, 4,621,011, 4,734,393, 5,019,564 or 5,720,138. The granules will comprise about 10-100% by weight plant fiber and about 0-90% by weight mineral fiber. The plant fibers form interlocking bonds to maintain the integrity of the granules. In a preferred embodiment, the cellulosic granules will comprise about 40-100% by weight plant fiber and about 60-90% by weight mineral fiber.

The plant fiber may come from any available cellulosic source including, for example, paper pulp, paper sludge, sugar cane bagasse, sugar beet pulp, potato pulp, citrus pulp, peanut hulls, rice hulls, peat moss, wood fiber, wood particles (saw dust, sander dust and wood flour), ground-up wood waste, and other cellulose-containing fibrous materials. Paper sludge is preferably preferred and de-inked paper sludge having about 30-90% by weight fiber is particularly preferred. Also, it is desirable to include longer cellulosic fibers, such as fibers in the range of about 1-10 mm in length.

The preparation of cellulosic granules from plant fiber may be facilitated by the addition of binders at a level of about 0.5 to 25% by weight and preferably at a level of about 1.0 to 10% by weight, based on the weight of the plant fiber. Binders may be chosen from the following: fuller's earth, guar gum, derivatives of guar gum, sodium carboxymethylcellulose, tapioca dextrin, gum Arabic, gum acacia, locust bean gum, calcium lignosulfonate, lignosulfonic acid (including sodium salt and sugared forms), polyvinyl alchohol, polyvinyl chloride, sodium polyacrylate, carrageenan, methylcellulose, carboxmethylcellulose, hydroxyethylcellulose, hydroxypropyl methylcellulose, xanthan gum, karaya gum, methyl paraben, potassium sorbate, bentonite, wheat starch, potato starch, flour, hydroxyethylated starch, latex polymer, corn syrup, pectin, and dextran. Among these binders, the natural gum binders are preferred.

After the quality adjustment, the plant fiber may be agglomerated or granulated by agitating the mixture with added water in an agglomeration device such as a drum pelletizer, disk pelletizer, pinmill, or granulator. The use of a pinmill is preferred. The fiber content of the solids in the mixture should exceed at least 10%-15% by weight and will preferably be as high as possible, with mineral fillers constituting the remainder.

During agitation, the fibers begin to interlock and bond together to form the granules, the size of which is determined by the water/solids ratio, the time elapsed in the agglomeration process, and the fiber/filler ratio.

The granules may be next tumbled for a period of time (“residence time”) in a separate tumbling device. The preferred residence time in the tumbling device is in the range of about 1 to 60 minutes, with a residence time of about 15 to 20 minutes being more preferred. The tumbling action produces enhanced granule-against-granule interaction, which is believed to decrease or eliminate undesirable protruding fibers to help prevent sticking to the animals' coat. It may be desirable to add water at a rate sufficient to increase the moisture level of the incoming granules by up to about 3% to enhance the flowability of the final product. It is preferred that the moisture level of the incoming granules be increased by approximately 1.5%.

The tumbling action may be achieved using a generally horizontal tube or rolling device which rotates about its longitudinal axis and is positioned at a slight angle of about 1-5 degrees to facilitate the flow of the granules onto a discharge belt. Positioning at an angle of about 1.5 degrees is preferred. The angle can be either an incline or a decline from the inlet to the outlet, with a decline being preferred. Generally, the rolling device operates at a speed in the range of about 90 to 250 ft/min. More preferably, the rolling device operates at a speed in the range of about 150 to 220 ft/min, with a speed of about 188 ft/min being most preferred.

The diameter and length of the rolling device are dependent upon the scale of operation and the type of sludge used. It is preferred that the rolling device have a generally smooth inner surface.

The resulting rolled product is dried until the granule contains about 1%-10% moisture by weight. Drying is accomplished in any standard dryer such as a fluid bed dryer, turbo dryer, belt dryer or tray dryer at a temperature range of about 200° F. to 750° F.

The granules used in the present invention preferably will be from about 1.0 inch in diameter to 60 USA Standard mesh in size. Preferably they will be from about 0.5 inch to 30 USA Standard mesh in size. Also, the granules will have a weight in the range of about 8-50 pounds per cubic foot, and preferably about 30-40 pounds per cubic foot.

The resilience and compressibility of the granules is an important feature. The resilience and compressibility of the cellulosic granules make the bedding far more comfortable to the animal than prior art beddings. Also, unlike prior beddings, the cellulose granules compress underfoot and resume much of their original size and shape after the animal's weight is removed. Wood and straw beddings cannot compress when subjected to these pressures and therefore tend to become crushed and disintegrate as the animals walk about on the bedding in the stall, making cleanup more difficult and releasing potentially problematic small pieces and fines.

In preferred embodiments, the granules will include additives such as biocides, fungicides, antimicrobials, insect repellants and fragrances. The use of biopesticides derived from natural materials are particularly preferred since they are less toxic than conventional pesticides. For example, natural oils and plant extracts with pesticidal properties can be used.

Biocides and fungicides will prevent the formation of microorganisms which may be unhealthy to the large animals and which may produce undesirable odors. Insect repellants will help keep flies and other insects away from the bedding after it is soiled. Fragrances, of course, will help cover any undesirable odors produced by the animal waste. Also, these materials may be added to the granules when they are manufactured or they may be applied after they are manufactured and before packaging/shipping. Alternatively, these materials may be microencapsulated and the microcapsules applied to the surface of the granules or incorporated into the cellulosic material used to manufacture the granules. Thus, when microencapsulated materials are used, these materials generally will be fully enclosed and protected until the animal steps onto them breaking the microcapsules and releasing the contained material.

The cellulosic granules may also be used to deliver medication to the animals by directly spraying the medications onto the granules or by microencapsulating and then applying the microencapsulated medications to the granules as discussed above. Such medications can be used, for example, to surface treat the animals' skin, coats or hooves or inhaleable medications in volatile carriers can be used to treat, inter cilia, lung illnesses.

The bedding granules, if undyed, will be generally steel grey in color. They may, however, be treated with a dye to adjust their color and to make wetted granules (which become noticeably darker than adjacent dry granules) more readily identifiable. One particularly desirable color is green. Alternatively, the granules may be dyed in earth tone colors. Beddings dyed green or in earth tones will give the large animals the sense that they are in pasture, contributing to their comfort in the stall.

The large animal bedding system of the invention may include a shovel 30 with a screen 32 in its blade 34. Screen 32 will have the plurality of holes 36 to assist in removing animal waste and agglomerated granules from the bedding layer. The holes should be up to about 1.25 times the largest diameter of the granules. For example, when the largest diameter of the granules is about 0.5 inch, preferably the holes will be about 0.625 to 0.75 inch in diameter.

Shovel 30 is used for sifting the soiled granular bedding to retain debris while clean, dry granules drop through the holes 36. Since the bedding coats the feces, the feces also remains on top of the shovel as the clean granules drop through the screen.

When the horse (or other large animal) urinates in the horse stall the wetted granules provide an isolated area with granules that change color as well as stick together, so that this area can be identified and selectively removed. Horse feces (commonly referred to as “apples”) landing on the bedding will stick to and become coated with the cellulosic granules. The granule coating will draw moisture out of the feces, helping to control odor. Also, the otherwise sticky apples will be made far less sticky and will be enlarged by the granule coating, so that they will be easier to pick out of the bedding.

Finally, the cellulosic granule bedding, when spent, will make an excellent field applied fertilizer, carrying the urine absorbed by the granules and the collected feces to the application site. This organic matter will be released to the fertilized plants while the cellulose of the granules is degraded. Also, the spent granules may be readily composted before application. The spent granules are expected to be a particularly effective as a mushroom spawn supplement for enhancing yield in the growing of mushrooms. Alternatively, the spent granules can be readily incinerated and indeed in this way also can serve as a renewable energy source.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What we claim is:

1. A large animal bedding system comprising:
a large animal stall having a floor; and
a bedding layer of cellulosic granules distributed across the floor of the stall.

2. The system of system of claim 1 in which the layer of cellulosic granules is from about 0.5 to 6 inches in thickness.

3. The system of system of claim 1 in which the layer of cellulosic granules is from about 3 to 4 inches in thickness.

4. The large animal bedding system of claim 1 in which the cellulosic granules comprise about 10-100% by weight plant fiber and about 0 to 90% by weight mineral fiber.

5. The large animal bedding system of claim 4 in which the plant fiber is chosen from the group consisting of paper pulp, paper sludge, sugar cane bagasse, sugar beet pulp, potato pulp, citrus pulp, peanut hulls, rice hulls, peat moss, wood fiber, wood particles, and ground-up wood waste.

6. The large animal bedding system of claim 5 in which the plant fiber is chosen from the group consisting of saw dust, sander dust, wood flour, and around-up wood waste.

7. The large animal bedding system of claim 1 in which the plant fiber is de-inked paper sludge having about 30-90% by weight fiber.

8. The large animal bedding system of claim 7 in which the paper sludge includes cellulosic fibers having a length in the range of about 1-10 mm.

9. The large animal bedding system of claim 1 in which the granules contain about 1-10% by weight moisture.

10. The large animal bedding system of claim 1 in which the granules are from about 1.0 inch in diameter to 60 USA standard mesh in size.

11. The large animal bedding system of claim 1 in which the granules are from about 0.5 inch to 30 USA standard mesh in size.

12. The large animal bedding system of claim 1 in which the granules have a weight in the range of about 8-50 pounds per cubic foot.

13. The large animal bedding system of claim 1 in which the granules have a weight in the range of about 30-40 pounds per cubic foot.

14. The large animal bedding system of claim 1 in which the granules include additives chosen from the group consisting of: biocides, fungicides, antimicrobials, insect repellants, fragrances, and medications.

15. The large animal bedding system of claim 1 in which the cellulosic granules include microencapsulated medications.

16. The large animal bedding system of claim 1 in which the granules are treated with a dye that enables the granules to darken when wetted, whereby wetted granules are rendered more readily identifiable.

17. The large animal bedding system of claim 1 including a shovel having a blade and a screen in the blade where the screen has a plurality of holes to assist in removing animal waste and agglomerated granules from the bedding layer.

18. The large animal bedding system of claim 17 in which the holes are about 1.25 times the largest diameter of the granules.

19. A large animal bedding system comprising:
a large animal stall having a floor; and
a bedding layer of from about 0.5 to 6 inches in thickness of cellulosic granules distributed across the floor of the stall where the granules contain about 1-10% by weight moisture, are from about 1.0 inch in diameter to 60 USA standard mesh in size, and have a weight in the range of about 8-50 pounds per cubic foot.
